(19) United States
(12) Patent Application Publication
(10) Pub. No.: US 2007/0242963 A1
(43) Pub. Date: Oct. 18, 2007

(54) Print media processing apparatus and jam detection method for the same

(75) Inventors: Takashi Saikawa, Shiojiri-shi (JP); Atsushi Natsuno, Matsumoto-shi (JP); Yoshiaki Kinoshita, Nagano-ken (JP); Masanori Hayashi, Nagano-ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/787,130

(22) Filed: Apr. 13, 2007

(30) Foreign Application Priority Data
Apr. 13, 2006 (JP) 2006-110708

(51) Int. Cl. G03G 15/00

(52) U.S. Cl. 399/21

(57) ABSTRACT

The print media processing apparatus has a function for detecting paper jams, and uses a validation detector and a discharge detector as a plurality of jam detection means that operate at different detection levels and independently of each other.

The present claims priority under 35 U.S.C. § 119 from Japanese Application Number 2006-110708, filed on Apr. 13, 2006, which is hereby incorporated by reference in its entirely.

### BACKGROUND OF THE INVENTION

1. Technical Field

The present invention relates to a media processing device having a function for detecting media jams.

2. Related Art

Print media processing apparatuses for reading information printed on a personal or business check or other type of slip or printing on a slip while conveying the slip through a transportation path are known. This type of print media processing apparatus commonly has a roll paper printing unit for printing on roll paper or other type of continuous print medium to issue sales receipts, event tickets, coupons, and other types of ticket forms, and a slip printing unit for printing on slips such as personal or business checks while conveying the slip through the transportation path, thus rendering a hybrid print media processing apparatus that combines a continuous medium printing function and a slip printing function with the ability to read magnetic ink characters and images printed on the slip form.

A magnetic ink character reader (MICR) is generally used to read information printed in magnetic ink (magnetic ink characters), and an image scanner is commonly used for imaging the media. These reading devices are disposed facing the transportation path to read the content of interest as the print medium travels passed the reading position of the reading device (image scanner or MICR device). A print head is also disposed at the downstream end of the transportation path for printing to the print medium after the reading process is completed. This type of printer also typically has a function for detecting jams (see, for example, Japanese Unexamined Patent Appl. Pub. 2005-103814, pages 5 to 10 and FIG. 5). Detecting a media jam uses the output of a detector disposed at a specific location on the transportation path and determines if a jam has occurred by detecting the presence of paper based on output from the detector.

A plurality of detectors may also be disposed in the transportation path and jam detection may be based on output from one or two detectors. When two detectors are used, a jam is detected unless both ends of the form are detected at the same time.

FIG. 7 is a plan view showing the positions of paper detectors disposed in the transportation path in a print media processing apparatus according to the related art. This arrangement has four paper detectors disposed along a U-shaped paper transportation path, including an ASF detector 9 (paper supply unit detector) disposed near the exit side of the auto sheet feeder (ASF), a TOF (top of form) detector 10 disposed near the image scanner (not shown in the figure), a validation detector 26 disposed near the input side of a validation slip processing unit, and a discharge detector 28 located near the paper exit from the transportation path. These detectors are arranged to detect if the processed medium is located at the detector.

Because of the need to determine if a check or other slip has been suitably conveyed or inserted to the printing position in a print media processing apparatus having four paper detectors disposed as described above, the validation detector 26 and the discharge detector 28 must be disposed as shown in FIG. 8 at an interval shorter than the shortest standard size of check that will be processed. More specifically, the validation detector 26 and the discharge detector 28 are disposed to simultaneously detect the trailing end and the leading end, respectively, of the paper.

As shown in the figure, however, if the two detectors are disposed to detect the corners of the conveyed or inserted media and one of the corners of the inserted slip is folded over or torn off, the detectors cannot simultaneously detect both ends of the slip and the print media processing apparatus of the related art erroneously determines that a jam has occurred even though the paper is correctly positioned to the detectors.

While slips with a folded corner can be correctly detected by basing jam detection on detecting either the leading end or trailing end of the slip, thereby loosening the conditions for paper detection, the primary need for reliable jam detection cannot be met.

### SUMMARY

The present invention is directed to detecting slips that are missing a corner because the corner is folded or torn, for example, while also affording reliable jam detection.

A print media processing apparatus according to a preferred aspect of the invention performs a function of detecting paper jams, and a plurality of jam detectors that operate independently of each other at different detection levels.

By using a plurality of jam detectors that operate at different detection levels, paper jams can be selectively detected using a high detection level or a low detection level. Forms with a folded or torn corner can therefore be detected and saved for processing when jam detection is set to the low detection level, and jams can be reliably detected when jam detection is set to the high detection level.

Preferably, the print media processing apparatus also has a controller that switches to jam detection at a low detection level when a jam is detected at the high jam detection level.

Paper jams are thus detected using the high detection level during normal operation, and jam detection is switched to the low detection level if a jam is detected because a form with a folded or torn corner is conveyed. This meets the demand for both reliable jam detection and being able to save and process forms with a torn corner, for example.

Further, preferably the jam detection means of the print media processing apparatus has a detector that detects a jam unless all of the plurality of detectors detect the form; and a detector that detects a jam unless at least one of the plural detector detects the form.

Yet further preferably, the jam detection means has a detector disposed at a position for detecting a corner at the leading end of the form; and a detector disposed at a position for detecting a corner at the trailing end of the form. This enables reliable detection of forms with a folded or torn corner.

By using a plurality of jam detectors that operate at different detection levels, the invention enables the detection of paper jams using a high sensitivity detection level or a low sensitivity detection level. The low detection level enables saving forms that have a damaged corner, and the high detection level enables reliable jam detection.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a print media processing apparatus according to a preferred embodiment of the invention.

FIG. 2 is a top view of the print media processing apparatus shown in FIG. 1.

FIG. 3 is a schematic diagram showing the paper transportation path in the print media processing apparatus shown in FIG. 1.

FIG. 4 is a schematic top view showing the internal arrangement of the print media processing apparatus shown in FIG. 1.

FIG. 5 is a block diagram describing jam detection control using a paper detector in the print media processing system according to the invention.

FIG. 6 is a flow chart describing jam detection control in the print media processing system according to the invention.

FIG. 7 is a schematic diagram showing the location of paper detectors disposed to the transportation path in a print media processing apparatus according to the related art.

FIG. 8 is a schematic diagram showing the relative positions of the validation detector and the discharge detector in the print media processing apparatus according to the related art.

### DESCRIPTION OF EMBODIMENTS

Preferred embodiments of the present invention are described below with reference to the accompanying figures.

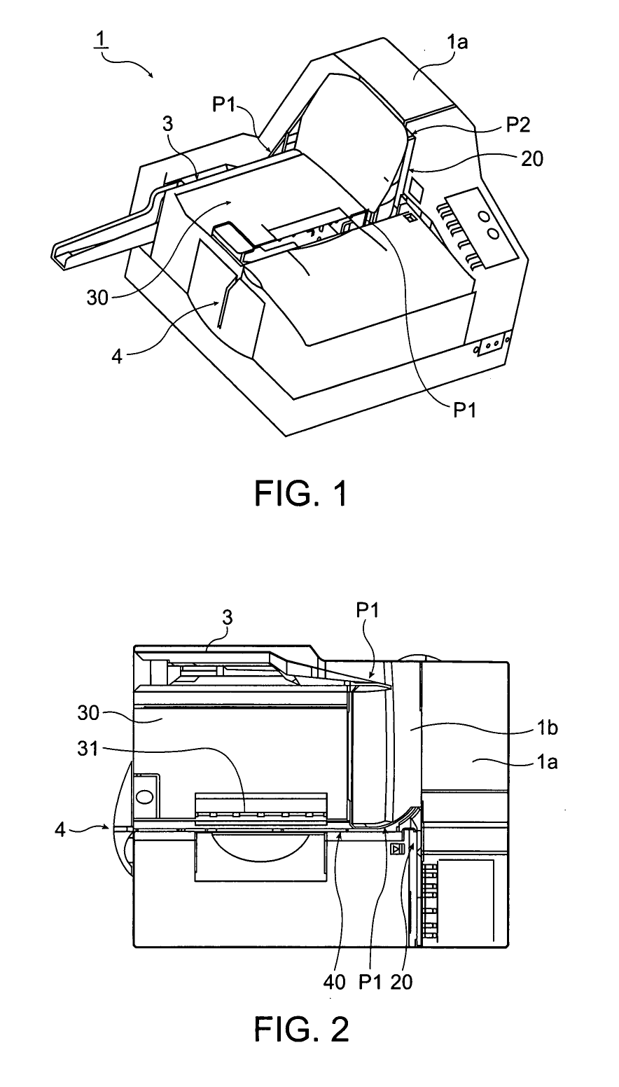

As shown in FIG. 1 to FIG. 4, the print media processing apparatus 1 according to this embodiment of the invention can read both sides of a check S, read magnetic ink characters from the check S, and print an endorsement on the check S as checks S loaded in an automatic sheet feeder (ASF) 3 (paper supply unit) are conveyed through a paper transportation path P1 that is formed in the printer case 1a.

The print media processing apparatus 1 can also read both sides of a card C that is inserted from a card insertion slot 20 as the card C is conveyed through a second paper transportation path P2 that is also rendered in the printer case 1a.

A validation slip insertion slot 40 is rendered above the straight portion on the downstream side of the paper transportation path P1 as shown in FIG. 2 so that validation slips can be inserted. The print media processing apparatus 1 can also print on these validation slips.

The print media processing apparatus 1 in this embodiment of the invention is thus a multifunction hybrid printer that has an image scanner function and a magnetic ink character reader function, and can print on checks S and validation slips.

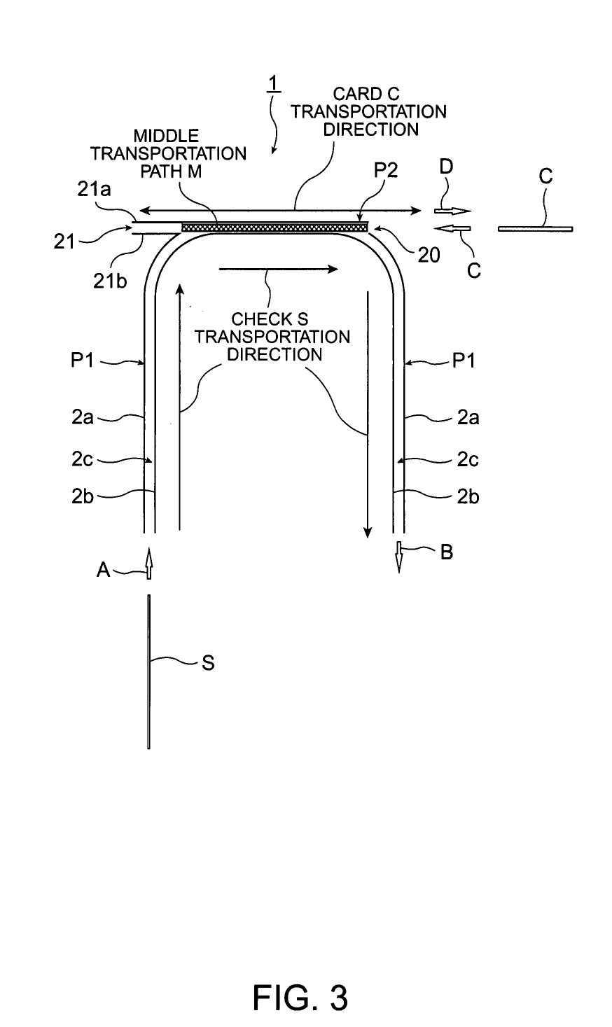

As shown in FIG. 3, the paper transportation path P1 for conveying the checks S is substantially U-shaped, and the paper transportation path P2 for conveying cards C is straight so that stiff cards C can be conveyed. The paper transportation path P1 and the paper transportation path P2 share the portion of the paper transportation path P1 that is at the bottom of the U between the two straight legs of the U shape. This common part of the transportation path is referred to herein as the middle transportation path M.

The reading devices are disposed in this middle transportation path M. As shown in FIG. 2, the portion of the paper transportation path P1 that is above the middle transportation path M is covered by a transportation path cover 1b that is part of the printer case 1a. This transportation path cover 1b covers and thus protects the reading devices that are disposed in the middle transportation path M from the outside.

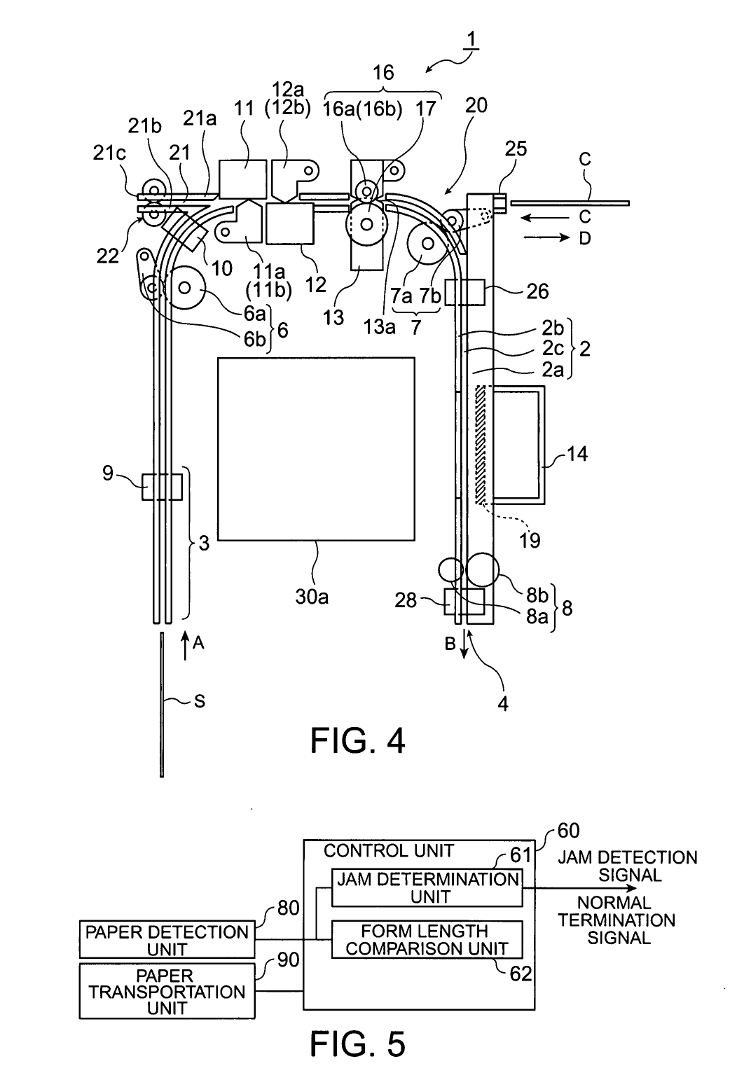

As shown in FIG. 3, the paper transportation path P1 has a transportation channel 2c rendered between an outside guide 2a and an inside guide 2b, and the checks S are conveyed through the transportation channel 2c. As shown in FIG. 2 and FIG. 4, the ASF 3 for stocking a plurality of checks S is disposed on the upstream side of the paper transportation path P1. The checks S are inserted in the paper transportation path P1 from the ASF 3 in the direction of arrow A in FIG. 4, and the multiple checks S stocked in the ASF 3 are separated and fed one by one into the paper transportation path P1.

The paper transportation unit disposed in the paper transportation path P1 for conveying the checks S includes paper transportation rollers 6 on the upstream side of the middle transportation path M, middle transportation rollers 16 disposed to the middle transportation path M, second transportation rollers 7 located on the downstream side of the middle transportation path M, and discharge rollers 8 before the paper exit.

The paper transportation rollers 6 include a drive roller 6a on one side of the paper transportation path P1 and a pressure roller 6b disposed on the other side of the paper transportation path P1 opposite the drive roller 6a.

The second transportation rollers 7 include a drive roller 7a on one side of the paper transportation path P1 and a pressure roller 7b disposed on the other side of the paper transportation path P1 opposite the drive roller 7a.

As shown in FIG. 4, the middle transportation rollers 16 include a bottom pressure roller 16a disposed at the lower part of the paper transportation path P1, an upper pressure roller 16b disposed at the upper part of the paper transportation path P1, and a drive roller 17 opposing the bottom pressure roller 16a and upper pressure roller 16b from the other side of the middle transportation path M.

A check S fed into the paper transportation path P1 by the ASF 3 is conveyed through the middle transportation path M by the paper transportation rollers 6, the middle transportation rollers 16, and the second transportation rollers 7, and is then discharged in the direction of arrow B from the paper exit 4 by the discharge rollers 8.

If the width (height) of a check S is shorter than a predetermined amount, the bottom pressure roller 16b and the drive roller 17 in the middle transportation roller 16 assembly are used to convey the check S. If the width (height) of the check S is greater than or equal to this predetermined amount, the bottom pressure roller 16a, the upper pressure roller 16b, and the drive roller 17 of the middle transportation roller 16 assembly convey the check S.

A first image scanner 11 and a second image scanner 12 for scanning slips and cards are disposed in the middle transportation path M at offset positions along the transportation direction as shown in FIG. 4. Both the first image scanner 11 and the second image scanner 12 are CIS (contact image sensor) scanners.

The first image scanner 11 and the second image scanner 12 each expose one side of the check S or card C travelling through the middle transportation path M to light, detect the light reflected from the check S or card C by means of a photoreceptor array (an array of photoelectric conversion devices), and convert the detected light to electric signals representing one line of the image. A two-dimensional image of the front and back of the medium being scanned is sequentially built by the first image scanner 11 and the second image scanner 12 sequentially scanning each line of the back and front of the check S or other medium.

A magnetic ink character reading device (MICR) 13 for reading magnetic ink characters is disposed below the drive roller 17. The MICR 13 is a sensor for reading magnetic ink characters printed on the face of the check S. The MICR 13 reads the surface of the check S pressed against the surface of the MICR 13 by a pressure lever disposed opposite the MICR 13 on the other side of the middle transportation path M. In this embodiment of the invention the MICR 13 is disposed for reading the magnetic ink character recording area 71 containing the checking account number and other information printed in magnetic ink.

The carriage 14 is disposed in the straight portion of the paper transportation path P1 between the second transportation rollers 7 and the discharge rollers 8 so that the carriage 14 can move linearly along the paper transportation path P1. A print head 19 having a plurality of nozzles for discharging ink is disposed on the carriage 14. Ink is discharged from the plural nozzles of the print head 19 in response to commands from the host computer (not shown in the figure) to print an endorsement on the check S, to print on validation slips, and to print on roll paper.

The paper detectors disposed in the paper transportation path P1 are described next. Four paper detectors are disposed in the paper transportation path P1, including the ASF detector (paper supply unit detector) 9, TOF (top of form) detector 10, validation slip detector 26, and discharge detector 28. These detectors 9, 10, 26, and 28 are optical paper detectors, for example, rendered to detect the presence of paper in front of the detector.

The ASF detector 9 is disposed near the discharge side end of the ASF 3 to detect a check S delivered from the ASF 3.

The TOF detector 10 is disposed between the ASF 3 and first image scanner 11 for detecting media delivered to the first image scanner 11. The length of a check S can be accurately measured by using the TOF detector 10 to detect the leading end and the trailing end of the check S.

The validation slip detector 26 is disposed in the straight portion on the downstream side of the second transportation rollers 7, and detects if a validation slip is inserted from the validation slip insertion slot 40.

The discharge detector 28 is disposed near the paper exit 4 and detects each check S discharged from the paper exit 4.

FIG. 5 is a block diagram of jam detection control using a paper detector in the print media processing apparatus according to this aspect of the invention. The main parts of the jam detection control circuit in this embodiment of the invention are the control unit 60, paper detection unit 80, and the paper transportation unit 90.

The control unit 60 is the central processing unit controlling overall operation of the print medium processing apparatus 1, and commands from the control unit 60 control driving the paper detection unit 80, the paper transportation unit 90, and the reading devices.

The paper detection unit 80 uses the TOF detector 10 to detect the length of each check S travelling through the paper transportation path P1.

The validation detector 26 and discharge detector 28 detect the leading end and the trailing end, respectively, of the paper at the printing position.

The paper transportation unit 90 is the transportation control unit that controls conveying of the checks S by rotationally driving the paper transportation rollers 6, the middle transportation rollers 16, and the second transportation rollers 7 by means of a stepping motor not shown.

The control unit 60 has a jam determination unit 61 and a form length comparison unit 62, and uses output from these units to determine if a paper jam has occurred. The jam determination unit 61 determines at the specified detection level whether a paper jam has occurred based on the leading end and trailing end detection results output from the validation detector 26 and the discharge detector 28. This determination is made at the validation position, that is, at the printing position for printing to slips.

The form length comparison unit 62 calculates the length of the check S based on the detection signal from the paper detection unit 80 and the number of steps that the stepping motor turns, compares this calculated check S length with the standard form length, and determines if the measured check length equals the standard check length. If the calculated length of the check S is shorter than the standard check length, the form length comparison unit 62 returns a paper length error caused by double feeding, for example, to the jam determination unit 61.

Operation of the print media processing apparatus according to this aspect of the invention is described next. The reading process executed before jam detection begins is described first using a check or similar slip by way of example.

When a check S is loaded into the ASF 3 and a specific read command is asserted, the control unit 60 of the print medium processing apparatus 1 drives the stepping motor by means of the paper transportation unit 90 in order to advance the check S. Driving the stepping motor causes the paper transportation rollers 6, the second transportation rollers 7, and the middle transportation rollers 16 to start turning, and carries the check S through the first paper transportation path P1. When the leading end of the check S reaches the TOF detector 10, the TOF detector 10 detects the leading edge of the check S and outputs a corresponding detection signal through the paper detection unit 80 to the control unit 60.

Transporting of the check S continues as the image scanners 11 and 12 image the front and back of the check S and the MICR 13 reads the magnetic ink characters. Note that these reading devices are known and further description thereof is thus omitted. As the check S is conveyed and scanned, the control unit 60 counts the number of steps advanced by the stepping motor after the paper detection signal from the TOF detector 10 is received, and instructs the appropriate reading devices to read the check S when the check S reaches the corresponding reading positions.

The TOF detector 10 then detects the trailing end of the check S and outputs a trailing end detection signal through the paper detection unit 80 to the control unit 60.

The form length comparison unit 62 of the control unit 60 then calculates the length of the paper based on the number of steps advanced by the stepping motor between when the TOF detector 10 detects the leading end and when it detects the trailing end of the check S. The check S is then sequentially fed through the first paper transportation path P1 to the printing position.

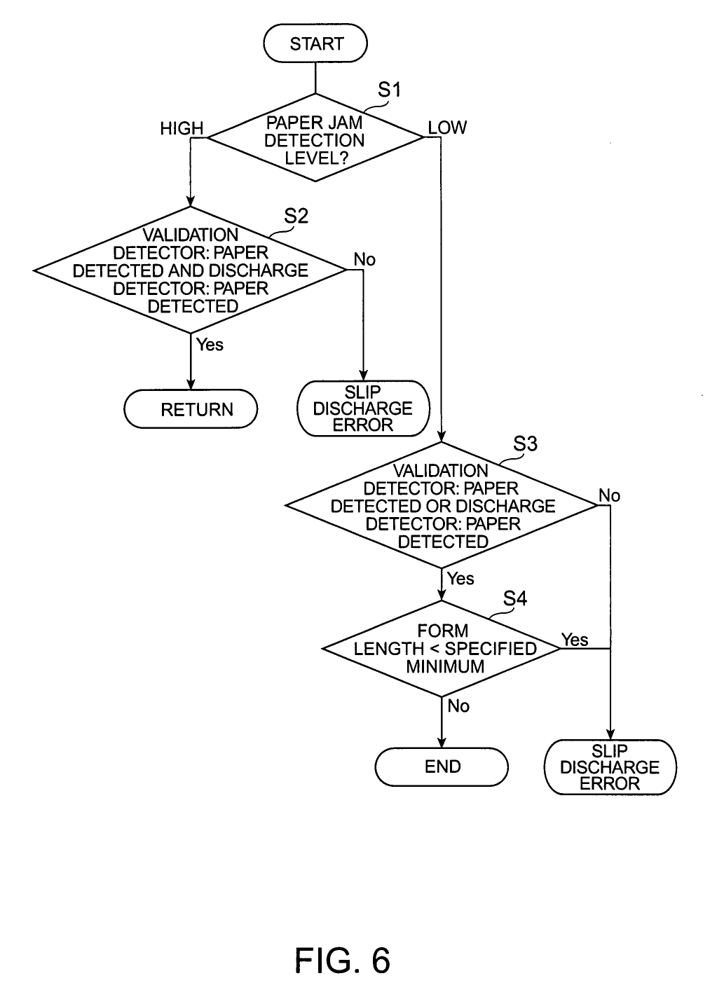

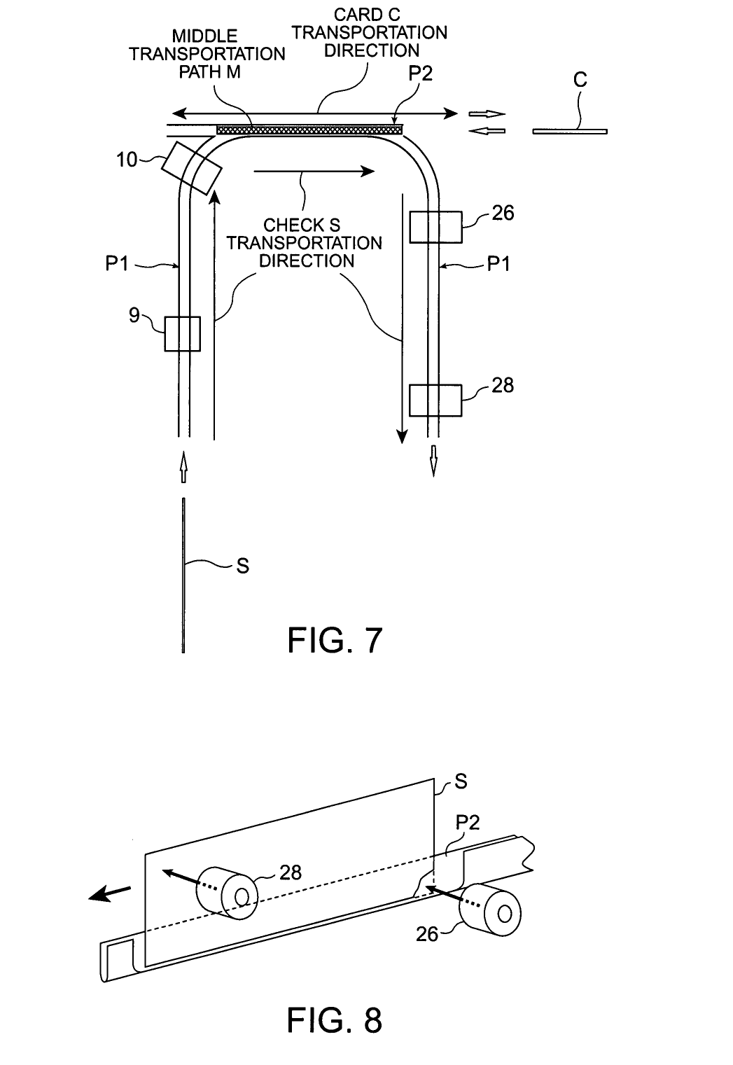

The jam detection operation of the print media processing apparatus according to this aspect of the invention is described next with reference to FIG. 6.

FIG. 6 is a flow chart of the jam detection process in the print media processing apparatus according to this embodiment of the invention. The validation detector and discharge detector are used as a plurality of jam detectors that operate independently at different detection levels, and this aspect of the invention switches between jam detection using a high detection level and jam detection using a low detection level. Note that the high detection level is the normal detection level and the low detection level is the level at which printing continues even if a corner of the check or other slip is folded over or torn off.

When a slip is carried by the process described above to the position of the validation detector at the beginning of the printing position for checks and slips, the control unit 60 of the print media processing apparatus decides the detection level setting (step S1). This detection level can be set in advance by the user of the print media processing apparatus.

When the detection level is set to the high detection level, the jam determination unit 61 of the control unit 60 receives the paper detection output from the validation detector 26 and discharge detector 28 by means of the paper detection unit 80 (step S2). If the validation detector returns Paper Detected and the discharge detector also returns Paper Detected, the jam determination unit 61 determines that the form was conveyed to the printing position without error and outputs the normal termination signal (step S2 returns Yes). Operation therefore proceeds to the next printing process.

If the high detection level is set and the validation detector and discharge detector return any other result, such as the validation detector returning Paper Detected and the discharge detector returning Paper Not Detected, or the validation detector returning Paper Not Detected and the discharge detector returning Paper Detected, or the validation detector returning Paper Not Detected and the discharge detector returning Paper Not Detected, the jam determination unit 61 determines that a jam occurred and outputs a slip discharge error signal (step S2 returns No). If the detection level is set to high and part of the leading end, or part of the trailing end, or a part of both the leading end and the trailing end are folded over or torn, this aspect of the invention thus determines that a jam occurred. This detection level therefore affords strict jam detection.

If the detection level is set to the low level, the jam determination unit 61 of the control unit 60 receives the paper detection results of the validation detector 26 and the discharge detector 28 from the paper detection unit 80, and goes to the form length comparison step if the validation detector returns Paper Detected or the discharge detector returns Paper Detected (step S3 returns Yes).

The form length comparison unit 62 compares the minimum form length with the form length calculated from the paper feed distance between when the TOF detector 10 (see FIG. 4) detects the leading end and when the TOF detector 10 detects the trailing end of the form (step S4).

If the calculated form length is greater than or equal to this minimum length, the form length comparison unit 62 determines that the slip advanced normally to the printing position (step S4 returns No), and outputs the normal termination signal. Operation can therefore proceed to the next printing process.

If the calculated form length is less than the minimum length, the form length comparison unit 62 outputs a slip discharge error signal (step S4 returns Yes), and determines that a jam occurred.

If the detection level is set to the low detection level, a jam is only detected when the validation detector returns No Paper Detected and the discharge detector also returns No Paper Detected, and the jam determination unit 61 outputs the slip discharge error signal (step S3 returns No).

More specifically, when the low detection level is set, the printing process does not execute only if a particularly damaged check S that is folded or torn at both the leading end and the trailing end is advanced or inserted to the printing position. If a check that is folded or torn at only the leading end or only the trailing end is appropriately conveyed to the printing position, the check is saved for the following printing process. This detection level thus makes jam detection less accurate but can save and finish processing checks that are slightly damaged at the end.

To summarize this process, when the detection level is low and the discharge detector detects a form, form detection ends unconditionally, that is, the printing process can be enabled. If both the validation detector and the discharge detector do not detect a form, a jam may have occurred while conveying the form through the readers or when inserting the slip, and a slip discharge error is returned.

This aspect of the invention enables the user of the print media processing apparatus to set the detection level, but the detection level can be set to the high detection level by default and the detection level can be automatically reset to the low detection level if a jam is detected at the high detection level.

This aspect of the invention is also described as using the validation detector and the discharge detector and switching the form detection level between a high sensitivity jam detection level and a low sensitivity jam detection level, but the invention is not so limited. More particularly, a different combination of a plurality of independently operating jam detectors, such as the ASF detector and the TOF detector, can be used instead.

As described here in the print media processing apparatus according to the present invention uses a plurality of jam detectors that operate independently of each other at different detection levels, and switches appropriately between a high jam detection level and a low jam detection level. The invention thus enables reliable jam detection while also being able to save forms that have a corner that is folded over or torn.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A print media processing apparatus having a function for detecting paper jams, comprising:
a plurality of jam detection means that operate independently of each other at different detection levels.

2. The print media processing apparatus described in claim 1, further comprising:
a means for selecting one of a plurality of predefined jam detection levels;
means for switching to jam detection at a low detection level when a jam is detected at the high jam detection level.

3. The print media processing apparatus described in claim 1, wherein the jam detection means comprises:
a means that detects a jam unless all of the plural detection means detect the form; and
a means that detects a jam unless at least one of the plural detection means detects the form.

4. The print media processing apparatus described in claim 3, wherein the jam detection means comprises:
a detector disposed at a position for detecting a corner at the leading end of the form; and
a detector disposed at a position for detecting a corner at the trailing end of the form.

5. A jam detection method for detecting paper jams, comprising:
detecting a paper jam by means of jam detection at a high detection level; and
switching to jam detection at a low detection level if a jam is detected at the high detection level.

6. A jam detection method described in claim 5, comprising:
detecting a jam unless all of plural detection means detect the form; and
detecting a jam unless at least one of the plural detection means detects the form.

7. A print media processing apparatus having a function for detecting paper jams, comprising:
a transportation path for conveying a medium; and
a plurality of jam detectors that operate independently of each other at different detection levels.

8. The print media processing apparatus described in claim 7, further comprising:
a selector that selects one of a plurality of predefined jam detection levels; and
a switch that switches to jam detection at a low detection level when a jam is detected at the high jam detection level.

9. The print media processing apparatus described in claim 1, further comprising:
a form length comparison unit that calculates a length of a conveyed medium, compares the calculated length to a standard length, and returns a paper length error signal when the calculated length is less than the standard length.
